(19) United States
(12) Patent Application Publication
(10) Pub. No.: US 2008/0202477 A1
(43) Pub. Date: Aug. 28, 2008

(54) Fuel Injection Valve

(76) Inventor: Friedrich Boecking, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/088,252

(22) PCT Filed: Aug. 15, 2006
(86) PCT No.: PCT/EP2006/065327

§ 371 Date: Mar. 27, 2008

(30) Foreign Application Priority Data
Sep. 27, 2005 (DE) 10 2005 046 122.0

(51) Int. Cl. F02M 51/00

(52) U.S. Cl. 123/498

(57) ABSTRACT

A fuel injection valve according to the invention serves as an injector for fuel injection systems of air-compressing, auto-ignition internal combustion engines. A piezoelectric actuator of the fuel injection valve has a plurality of ceramic layers and a plurality of electrode layers arranged between the ceramic layers. A first electrode connection extends through a cut-out of a transition piece and into an internal recess of the actuator. The first electrode connection is surrounded in the cut-out of the transition piece by a sealing means. In addition, the first electrode connection is electrically connected to a first part of the electrode layers.

### PRIOR ART

The invention relates to a fuel injection valve for fuel injection systems of internal combustion engines. In particular, the invention relates to an injector for fuel injection systems of air-compressing, autoignition internal combustion engines.

WO 03/026033 A1 has disclosed a device for a fuel injection valve equipped with a piezoelectric actuator. The known actuator is equipped with contact paths that are inserted into internal recesses, which pass all the way through the actuator, in order to produce a connection to the positive electrodes of the actuator on the one hand and the negative electrodes on the other. In addition, an electrically insulating insulator layer is furnished to provide electrical insulation between an end surface of the actuator and a plate situated against the end surface of the actuator.

The device for a fuel injection valve known from WO 03/026033 A1 has the disadvantage that the placement of the contact paths inside the internal recesses makes the contacting complex and susceptible to malfunction. In particular, the known electrically insulating insulator layer, which is composed of enamel or plasma-deposited ceramic, is unable to assure a seal in relation to a highly pressurized medium, in particular fuel, so that a separate, closed actuator chamber in the fuel injection valve is required for the known actuator.

### ADVANTAGES OF THE INVENTION

The fuel injection valve according to the invention, with the defining characteristics of claim 1, has the advantage over the prior art that the contacting of the electrode layers by means of the electrode connection is reliably sealed off from external media, in particular highly pressurized fuel. In particular, fuel is prevented from penetrating into the internal recess in which the electrode connection is accommodated. The recess in the transition piece, which serves to guide the electrode connection, is also reliably sealed.

Advantageous modifications of the fuel injection valve disclosed in claim 1 are possible by means of the measures taken in the dependent claims.

It is advantageous that the recess provided in the transition piece is completely or largely filled with sealing material. In addition to a reliable seal of the recess, this also prevents the accumulation of fluid or gaseous media, in particular water-containing diesel fuel in fluid or gaseous form. The sealing material here can be composed of glass, thus providing the electrode connection with a melted glass covering that fills the recess of the transition piece.

Preferably, an electrically conducting conductor material is provided in a recess of the actuator and electrically connects the first electrode connection to the first group of electrode layers of the actuator. The conductor material can have an electrically conducting adhesive and/or a solder. Preferably, the conductor material is at least partially elastic in order to assure a reliable electrical contact with the first electrode connection in view of the periodically occurring expansion movements of the actuator. The recess of the actuator can be provided on an inside with an electrically conducting contact layer that connects the first group of electrode layers to one another. Depending on the respective embodiment, this makes it possible to further improve the electrical contacting of the electrode layers to one another and to the first electrode connection.

The transition piece is advantageously attached directly to the actuator. This has the advantage that there is only one boundary surface between the actuator and the transition piece, thus allowing for a reliable seal. It is also advantageous that the recess provided in the transition piece is adjacent to the recess provided in the actuator and, in a transition region in which the recess provided in the transition piece is adjacent to the recess provided in the actuator, an opening of the recess provided in the actuator encompasses an opening of the recess provided in the transition piece. This makes it possible to form a step that widens out from the recess of the transition piece to the recess of the actuator. This has the advantage that a sealing material protruding partway out from the recess of the transition piece, in particular a melted glass covering, can protrude into the recess of the actuator and be embedded in the conducting material. As a result, it is also possible in this case for the transition piece to be attached to the actuator without a gap.

It is advantageous that an externally placed second electrode connection is provided, which is electrically connected at least indirectly to a second group of electrode layers and is attached to the actuator on an outside of the actuator. As a result, the first group of electrode connections can adjoin only the inner recess of the actuator and the second group of electrode layers can adjoin only the outside of the actuator. In this case, the recess of the actuator can be provided essentially in the center of the actuator and can extend along an axis of the actuator. This permits a symmetrical design of the actuator, thus achieving a uniform expansion when the actuator is activated. In particular, this avoids a lateral tilting of the actuator when it is activated. This assures a flat contact of the transition piece against the actuator over the service life of the fuel injection valve, thus assuring a reliable seal for the contacting of the electrode layers.

### DRAWINGS

A preferred exemplary embodiment of the invention will be explained in greater detail in the description below in conjunction with the accompanying drawings in which corresponding elements are provided with matching reference numerals.

FIG. 1 is a schematic section through an exemplary embodiment of a fuel injection valve according to the invention and

FIG. 2 is a detailed depiction of the section labeled II in FIG. 1.

### DESCRIPTION OF THE EXEMPLARY EMBODIMENT

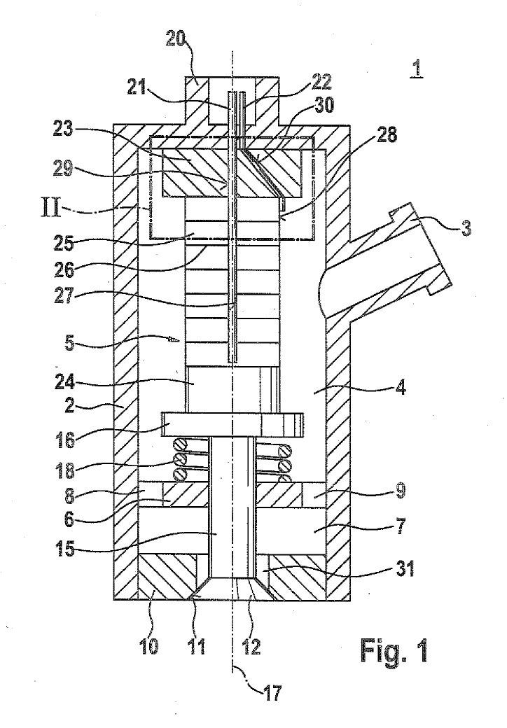

FIG. 1 shows an exemplary embodiment of the fuel injection valve 1 according to the invention. The fuel injection valve 1 can in particular be used as an injector for fuel injection systems of air-compressing, autoignition internal combustion engines. In particular, the fuel injection valve 1 is suited for commercial vehicles or passenger vehicles. A preferred use of the fuel injection valve 1 is in a fuel injection system with a common rail that delivers highly pressurized diesel fuel to a plurality of fuel injection valves. The fuel injection valve 1 is, however also suitable for use in other situations.

The fuel injection valve 1 has a valve housing 2 and a fuel inlet fitting 3 connected to the valve housing 2. A fuel line can be attached to the fuel inlet fitting 3 in order to introduce fuel into an actuator chamber 4 provided inside the valve housing 2. The actuator chamber 4 contains an actuator 5 of the fuel injection valve 1. A housing part 6 separates the actuator chamber 5 from a fuel chamber 7 likewise provided inside the valve housing 2. The housing part 6 is provided with through openings 8, 9 in order to convey the supplied fuel through the actuator chamber 4 into the fuel chamber 7.

A valve seat body 10 connected to the valve housing 2 is provided with a valve seat surface 11 that cooperates with a valve-closure member 12 to form a sealing seat. The valve-closure member 12 is integrally joined to a valve needle 15 via which the valve-closure member 12 is connected to a pressure plate 16 provided in the actuator chamber 4. The valve needle 15 in this case is guided by the housing part 6 in the direction of an axis 17 of the fuel injection valve 1. A valve spring 18 exerts a closing force on the valve needle 15 by means of the pressure plate 16 so that the sealing seat formed between the valve-closure member 12 and the valve seat surface 11 is closed.

The valve housing 2 is also provided with a connecting element 20 for connecting an electrical supply line to the fuel injection valve 1. The electric supply line in this case can be connected by means of a plug to a first electrode connection 21 and a second electrode connection 22, which are routed to the actuator 5 through the housing 2 and through a transition piece 23 embodied in the form of an actuator foot. The actuator 5 is supported by means of the transition piece 23 against an inside of the valve housing 2. In addition, by means of an actuator head 24, the actuator 5 counteracts the force of the valve spring 18 against the pressure plate 16, as a result of which the valve spring 18 prestresses the actuator 5.

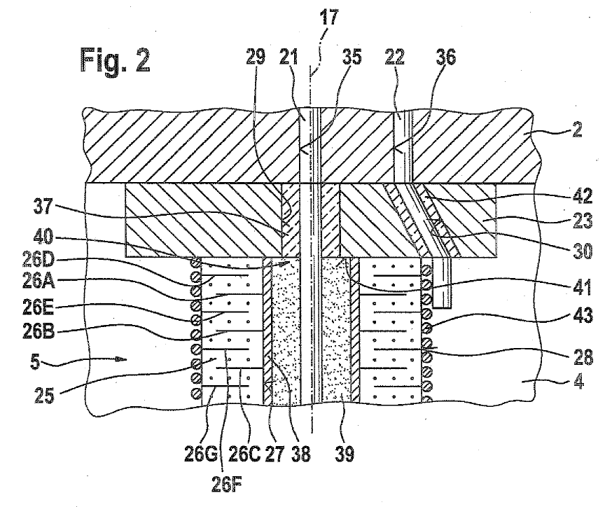

The piezoelectric actuator 5 has a multitude of ceramic layers 25 and a multitude of electrode layers 26 situated between the ceramic layers 25. A first group of electrode layers 26 are connected to the first electrode connection 21 and a second group of electrode layers 26 are connected to the second electrode connection 22. For example, the electrode layers 26 connected to the first electrode connection 21 constitute the positive electrodes of the actuator 5 while the electrode layers 26 connected to the second electrode connection 22 constitute its negative electrodes. The first electrode connection 21 is inserted into an internal recess 27 of the actuator 5; the recess 27 extends over the entire length of the actuator 5 or extends at least over an active region of the actuator 5 in which the electrode layers 26 are provided. The second electrode connection 22 is connected to the actuator 5 on an outside 28 of the actuator. The transition piece 23 has recesses 29, 30 extending all the way through it, through which the electrode connections 21, 22 are routed. The embodiment of the actuator 5, the transition piece 23, the electrode connections 21, 22, and their connection will be described in greater detail in conjunction with FIG. 2.

The electrode connections 21, 22 can supply current to the actuator 5, causing it to expand in the direction of the axis 17, thus opening the sealing seat formed between the valve-closure member 12 and the valve seat surface 11. This causes fuel to be sprayed from the fuel chamber 7 via an annular gap 31 and the open sealing seat. When the actuator 5 is switched into the currentless state, it contracts again thus closing the sealing seat embodied between the valve-closure member 12 and the valve seat surface 11.

FIG. 2 shows a detailed sectional view of the section labeled 11 in FIG. 1.

The valve housing 2 is provided with recesses 35, 36 that extend all the way through it. The transition piece 23 also has recesses 29, 30 extending all the way through it. The recess 35 of the valve housing 2 transitions into the recess 29 of the transition piece 23 and the cross section increases in step fashion from the valve housing 2 to the transition piece 23. The recess 36 of the valve housing 2 likewise transitions into the recess 30 of the transition piece 23 and the cross section increases in step fashion from the valve housing 2 to the transition piece 23. The recess 35 of the valve housing 2 and the recess 29 of the transition piece 23 are positioned so that they are at least approximately centered in relation to the axis 17 of the actuator 5 of the fuel injection valve 1. The first electrode connection 21 extends through both the valve housing 2 and the transition piece 23 and extends at least partway into the recess 27 of the actuator 5. The recess 29 of the transition piece 23 is filled with a sealing material 37. As a result, the sealing material 37 encompasses the first electrode connection 21 in the region of the recess 29. For example, the sealing material 37 can be composed of glass and can constitute a melted glass covering for the first electrode connection 21. The sealing material 37 provides a seal not only in relation to the interface between the valve housing 2 and the transition piece 23, but also in relation to the interface between the actuator 5 and the transition piece 23.

The inside of the recess 27 of the actuator 5 is provided with an electrically conducting contact layer 38. The contact later 38 connects the electrode layers 26A, 26B, 26C to one another. The electrode layers 26A, 26B, 26C and other electrode layers not shown in FIG. 2, which adjoin the recess 27 and are spaced apart from an outside 28 of the actuator 5, constitute the first group of electrode layers 26 and are connected to one another by means of the contact layer 38. Between the first electrode connection 21, which extends inside the recess 27 of the actuator 5, and the contact layer 38, an electrically conductive conductor material 39 is provided, which can have an electrically conductive adhesive, a solder, or the like. The conductor material 39 and the contact layer 38 electrically connect the first electrode connection 21 to the electrode layers 26A, 26B, 26C. The conductor material 39 in this case prevents fluid and gaseous media from penetrating into the recess 27 of the actuator 5. The cross section of the recess 27 of the actuator 5 is greater than the cross section of the recess 29 of the transition piece 23 so that an opening of the recess 27 encompasses an opening of the recess 29 in a transition region 40, forming a step 41 that widens out from the recess 29 of the transition piece 23 to the recess 27 of the actuator 5. As a result, an excess of relatively hard sealing material 37 can be pressed into the relatively soft conductor material 39 without producing a gap between the actuator 5 and the transition piece 23.

The recess 30 of the transition piece 23 is likewise filled with a sealing material 42 that is embodied as analogous to the sealing material 37. On the outside 28 of the actuator 5 an electrode contact 43 in the form of a single or double screen is provided that is connected to the electrode layers 26D, 26E, 26F, 26G, which adjoin the outside 28 of the actuator 5 and are spaced apart from the recess 27 of the actuator 5. The electrode contact 43 electrically connects the external, second electrode connection 22 to the electrode layers 26D, 26E, 26F, 26G, which, together with other electrodes, constitute the second group of electrode layers 26.

The second electrode connection 22, the electrode contact 43, and the actuator 5 can also be encased on the side oriented toward the actuator chamber 4 by an insulating layer, in particular an elastomer casing or the like, in order to produce a seal in relation to the fuel contained in the actuator chamber 4.

Due to the symmetrical design of the actuator 5, when the electrode connection 21, 22 supplies current to the actuator 5 or switches it into a currentless state, a uniform expansion of the actuator 5 is achieved, thus preventing the actuator 5 from tilting, in particular preventing the occurrence of a gap between the actuator 5 and the transition piece 23 or the transition piece 24.

The first electrode connection 21 is embodied in the form of a pin-shaped electrode connection; the material of the electrode connection 21 is preferably comprised of Invar or the like.

The invention is not limited to the exemplary embodiment described above. In particular, the second electrode connection 22 can also be embodied in the form of a second internal electrode connection 22.

1-15. (canceled)

16. A fuel injection valve for fuel injection systems of air-compressing, autoignition internal combustion engines, the valve comprising a piezoelectric actuator equipped with a multitude of ceramic layers and a multitude of electrode layers situated between the ceramic layers, a valve-closure member actuatable by the actuator and cooperating with a valve seat surface to foil a seating seat, a transition piece attached to the actuator, and at least one first electrode connection, the actuator having a least one internal recess that extends at least largely through an active region of the actuator in which the electrode layers are provided, the transition piece having at least one recess extending all the way through it, the first electrode connection extending through the recess of the transition piece and extending at least largely into the internal recess of the actuator in the region of the recess of the transition piece, the first electrode connection being at least partially encompassed by a sealing material that closes and seals the recess of the transition piece, and the first electrode connection being electrically connected at least indirectly to a first group of electrode layers.

17. The fuel injection valve according to claim 16, wherein at least the recess of the transition piece is at least largely filled with the sealing material.

18. The fuel injection valve according to claim 17, wherein the seating material encompassing the first electrode connection is composed of glass in order to embody a melted glass covering for the first electrode connection.

19. The fuel injection valve according to claim 16, further comprising an electrically conductive conductor material in the recess of the actuator and electrically connecting the electrode connection to the first group of electrode layers of the actuator.

20. The fuel injection valve according to claim 17, further comprising an electrically conductive conductor material in the recess of the actuator and electrically connecting the electrode connection to the first group of electrode layers of the actuator.

21. The fuel injection valve according to claim 18, further comprising an electrically conductive conductor material in the recess of the actuator and electrically connecting the electrode connection to the first group of electrode layers of the actuator.

22. The fuel injection valve according to claim 19, wherein the conductor material comprises an electrically conducting adhesive and/or a solder.

23. The fuel injection valve according to claim 16, further comprising an electrically conductive contact layer in the recess of the actuator, which contact layer connects the first group of electrode layers to one another.

24. The fuel injection valve according to claim 22, further comprising an electrically conductive contact layer in the recess of the actuator, which contact layer connects the first group of electrode layers to one another.

25. The fuel injection valve according to claim 16, wherein the first electrode connection is pin-shaped.

26. The fuel injection valve according to claim 16, wherein the transition piece is attached directly to the actuator.

27. The fuel injection valve according to claim 19, wherein the transition piece is attached directly to the actuator.

28. The fuel injection valve according to claim 16, wherein the recess in the transition piece is adjacent to the recess in the actuator.

29. The fuel injection valve according to claim 28, wherein, in a transition region in which the recess the transition piece is adjacent to the recess in the actuator, an opening of the recess in the actuator encompasses an opening of the recess the transition piece, thus forming a step that widens out from the recess of the transition piece to the recess of the actuator.

30. The fuel injection valve according to claim 16, further comprising an externally placed second electrode connection electrically connected at least indirectly to a second group of electrode layers, the second electrode connection being attached to the actuator on all outside of the actuator.

31. The fuel injection valve according to claim 30, further comprising an electrode contact on the outside of the actuator, and wherein the second electrode is connected to the electrode contact on the outside of the actuator and connects the second group of electrode layers to one another.

32. The fuel injection valve according to claim 30, wherein the first group of electrode layers adjoin the recess of the actuator and are spaced apart from the outside of the actuator and the second group of electrode layers are spaced apart from the recess of the actuator and adjoin the outside of the actuator.

33. The fuel injection valve according to claim 31, wherein the first group of electrode layers adjoin the recess of the actuator and are spaced apart from the outside of the actuator and the second group of electrode layers are spaced apart from the recess of the actuator and adjoin the outside of the actuator.

34. The fuel injection valve according to of claim 16, wherein the recess of the actuator extends at least essentially along an axis of the actuator.

35. The fuel injection valve according to claim 34, wherein the recess of the transition piece extends at least essentially in the direction of the axis of the actuator and is at least essentially adjacent to the recess of the actuator.
